(19) United States
(12) Patent Application Publication
(10) Pub. No.: US 2018/0207912 A1
(43) Pub. Date: Jul. 26, 2018

(54) A PLANT PROTEIN AND MODIFIED CLAY COMPOSITE

(71) Applicants: AGENCY FOR SCIENCE, TECHNOLOGY AND RESEARCH, Singapore (SG); National University of Singapore, Singapore (SG)

(72) Inventors: Xu LI, Singapore (SG); Yu Yuan CHIENG, Singapore (SG); Waibiao ZHOU, Singapore (SG)

(21) Appl. No.: 15/737,745

(22) PCT Filed: Jun. 20, 2016
(86) PCT No.: PCT/SG2016/050281

§ 371 Date: Dec. 18, 2017

(30) Foreign Application Priority Data
Jun. 18, 2015 (SG) 10201504851R

(51) Int. Cl. B32B 27/08; B32B 27/36; B32B 27/32; B32B 27/34; C08J 7/04; C08K 9/06; C08K 3/22; C08L 89/00

(52) U.S. Cl. CPC B32B 27/08; B32B 27/36; B32B 27/32; B32B 27/34; C08J 7/047; C08J 2489/00; C08K 3/22; C08L 89/00; B32B 2439/70; C08J 2405/08; C08K 9/06

(57) ABSTRACT

A polymer composite comprising a clay modified with a coupling agent such as an organosilane; and a plant protein matrix, wherein the coupling agent couples the modified clay to the plant protein polymeric matrix. An antimicrobial agent can also be coupled to the coupling agent. Suitable antimicrobial agents include chitosan and its derivatives, transition metals and inorganic oxides. A method of forming the polymer composite coating on a substrate, a multi-layered structure comprising said composite and a composition comprising the composite is also defined. The composite is useful in food packaging.

### TECHNICAL FIELD

The present invention generally relates to a polymer composite. The present invention also relates to a method of forming a polymer composite coating on a substrate.

### BACKGROUND ART

Plastic films have received much attention in a wide range of industrial applications, such as food packaging, due to their low cost, strength and stiffness, transparent and flexibility properties. The purpose of food packaging is to protect the food against microbial contamination by the surrounding environment, thereby prolonging its shelf life and maintaining its quality. For this reason, a desirable plastic packaging should possess good barrier properties against permeation of gases and vapours, and also with the ability to retard microbial penetration. However, commercially available plastic films such as polyethylene terephthalate (PET), polypropylene (PP) and polyethylene (PE) exhibit relatively poor barrier properties as compared to glass, aluminium foil and metalized film. In addition, such plastics are non-biodegradable, presenting risks to sustainability and creating environmental issues.

In order to improve the barrier property of a substrate or a packaged food, coating the substrate or packaged food is usually employed. Here, the substrate or packaged food is coated with a layer of a suitable material to act as a barrier between the substrate or the food and the external environment. With growing public health and environmental awareness, the use of sustainable materials that can act as a barrier against gas permeation and contamination by antimicrobial agent is highly desired.

Polymeric materials have been suggested as possible coating materials to preserve the quality of packaged food and to act as a physical barrier between an external environment and the food. An example of such polymer material is a zein film, which has been extensively studied as an oxygen barrier layer. However, zein film is known to be extremely brittle and while additives such as glycerol have been used to improve the mechanical strength of the zein film, the use of such additives may reduce the oxygen barrier performance of the zein film due to increased mobility of chain segments and free volume. In addition, zein films are low in strength, and have poor solubility issues.

An example of a food product that requires protection from an external environment includes eggs. Eggs are important protein resources that are highly susceptible to internal quality deterioration and microbial contamination during handling and storage. Egg deterioration is mainly due to the loss of moisture and carbon dioxide via the shell pores, which results in weight loss and increased of albumen pH, causing quality changes in albumen and yolk. Bacteria can easily penetrate through the shell pores, causing spoilage during transportation and storage. To overcome these problems, various coating materials have been investigated and applied to the surface of egg shells for preserving interior quality of eggs and extending shelf life. Among the coating materials, mineral oil chitosan have shown to be very promising and is currently used to preserve the internal quality of eggs. However, there are problems associated with oil coating such as the long period of time required for the drying process (which can take more than one day for each layer of coating), formation of thick coatings from the mineral oil, and greasy surfaces that are not suitable for handling.

There is a need to provide a polymer composite that overcomes, or at least ameliorates, one or more of the disadvantages described above. There is also a need to provide a multi-layered structure that is able to function as a coating that overcomes, or at least ameliorates, one or more of the disadvantages described above.

### SUMMARY OF INVENTION

According to a first aspect, there is provided a polymer composite comprising: (a) a clay modified with a coupling agent; and (b) a plant protein polymeric matrix, wherein said coupling agent couples said modified clay to said plant protein polymeric matrix.

Advantageously, the polymer composite may be able to act as a barrier layer against a gas for coating and packaging applications. The coating may also enhance the mechanical strength of the coated substrates or packaged food. The coating may also act as a barrier against moisture or water vapour.

According to a second aspect, there is provided a method of forming a polymer composite coating on a substrate comprising the step of applying a polymer composite composition on the substrate under conditions to form the coating thereon.

According to a third aspect, there is provided a multi-layered structure comprising: (a) a polymer composite layer; and (b) a polymer substrate layer, wherein the polymer composite layer is a layer comprised of: (i) a clay modified with a coupling agent; and (ii) a plant protein polymeric matrix.

According to a fourth aspect, there is provided a polymer composite composition comprising a liquid medium of (a) a clay modified with a coupling agent; and (b) a plant protein.

### Definitions

The following words and terms used herein shall have the meaning indicated:

The term “clay” as used herein refers to a naturally occurring material composed primarily of fine-grained minerals, which depending on the water content, can deform when a stress is applied on the clay, and become harder and non-deformable when heat is applied to the clay. Clay can be generally divided into four groups depending on their structures and contents, such as kaolinite, montmorillonite-smectite, illite, or chlorite. Clay is made of clay minerals that are structured within the clay as planes of cations, arranged in sheets, which may be tetrahedrally or octahedrally coordinated (with oxygen), which in turn are arranged into layers of tetrahedral and/or octahedral sheets. As such, it is possible to introduce additives into the clay by intercalating such additives into the region between the sheets. Where the clay is coupled with a coupling agent, the clay can be termed as modified clay. Hence, the term “modified clay” can refer to clays whose surface chemistry has been altered for example by the chemical reactions between the OH group on the clay surface and a coupling agent such as silane.

The term “plant protein” as used herein refers to protein derived from a plant source, such as from leaves, barks, seeds, grains, or roots, and which can used to form a polymeric matrix.

The term “prolamin” refers to any group of globular proteins that are found in plants, such as cereals. These proteins contain high levels of glutamic acid and proline. Suitable prolamin proteins include gliadin (wheat and rye), zein (corn), and kafirin (sorghum and millet). Suitable gliadin proteins include α-, β-, γ-, and ω-gliadins.

The term “polymer composite” as used herein represents a multicomponent material which is composed essentially of a polymeric matrix. The polymeric matrix is expected to extend and intercalate between the sheets of the multicomponent material.

The term “barrier” as used herein refers to a form of obstacle that guards against or prevents a gas such as oxygen or carbon dioxide from one side of the obstacle (usually the surrounding or external environment) from passing through the obstacle into the other side of the obstacle (usually an interior) to thereby prevent or reduce reactions with the gas from taking place. The bather may also be used to prevent or reduce the movement of water vapour through the obstacle.

The term “coating” as used herein refers to a deposit layer that is applied to part or all of an exposed surface of a substrate or packaged food.

The word “substantially” does not exclude “completely” e.g. a composition which is “substantially free” from Y may be completely free from Y. Where necessary, the word “substantially” may be omitted from the definition of the invention.

Unless specified otherwise, the terms “comprising” and “comprise”, and grammatical variants thereof, are intended to represent “open” or “inclusive” language such that they include recited elements but also permit inclusion of additional, un-recited elements.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and sub-generic groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF EMBODIMENTS

Exemplary, non-limiting embodiments of a polymer composite will now be disclosed. The polymer composite comprises clay modified with a coupling agent; and a plant protein polymeric matrix, wherein the coupling agent couples the modified clay to the plant protein polymeric matrix.

The polymer composite may further comprise an antimicrobial agent coupled to the coupling agent. The antimicrobial agent may be selected from the group consisting of chitosan, a chitosan derivative compound, a transition metal, an inorganic oxide and combinations thereof. Where the antimicrobial agent is the chitosan derivative compound, the chitosan derivative compound may be a chitosan-arginine compound, a chitosan-guanidine compound, a methyl-thiocarbamoyl chitosan derivative, a phenylthiocarbamoyl chitosan derivative and a chitosan-lysine compound. Exemplary types of chitosan derivatives are provided in US publication number US 2007/0281904, the disclosure of which is incorporated by reference. Where the antimicrobial agent is the transition metal, the transition metal may be selected from the group containing of copper, cobalt, nickel, zinc, silver, ruthenium, platinum, rhodium, iridium, palladium, osmium, manganese and combinations thereof. The transition metal may be part of a transition metal complex or a transition metal compound. The transition metal compound may be a transition metal salt that is able to confer the transition metal ion in a suitable solution or environment. It is to be appreciated that the type of transition metal complex or transition metal compound used as the antimicrobial agent may be one that is known to a person skilled in the art as long as it includes the transition metal mentioned herein. For example, the antimicrobial agent may be silver nitrate, silver nanoparticles or cationic polymers such as gelatine, polyethylenimine, poly(L-lysine), poly amido amine or poly [2-(N,N-dimethyl amino)ethyl methacrylate]. Where the antimicrobial agent is an inorganic oxide, the inorganic oxide may be selected from the group consisting of magnesium oxide, zinc oxide, silver oxide, titanium oxide, copper oxide and calcium oxide.

The clay modified with a coupling agent may have a plate-like structure with a high aspect ratio. The aspect ratio may be in the range of about 20 to about 400, about 20 to about 380, about 20 to about 360, about 20 to about 340, about 20 to about 320, about 20 to about 300, about 20 to about 280, about 20 to about 260, about 20 to about 240, about 20 to about 220, about 20 to about 200, about 20 to about 180, about 20 to about 160, about 20 to about 140, about 20 to about 120, about 20 to about 100, about 20 to about 80, about 20 to about 60, about 20 to about 40, about 40 to about 400, about 60 to about 400, about 80 to about 400, about 100 to about 400, about 120 to about 400, about 140 to about 400, about 160 to about 400, about 180 to about 400, about 200 to about 400, about 220 to about 400, about 240 to about 400, about 260 to about 400, about 280 to about 400, about 300 to about 400, about 320 to 400, about 340 to about 400, about 360 to about 400, or about 380 to about 400. The clay modified with a coupling agent may be selected from the group consisting of montmorillonite, halloysite, bentonite, laponite, kaolinite, saponite, vermiculite and combinations thereof. The clay modified with a coupling agent may also be termed as modified clay.

The modified clay may be coupled to the plant protein polymeric matrix via the coupling agent. The coupling agent may be a silane coupling agent. The silane coupling agent may be an organosilane coupling agent. The organosilane coupling agent may be selected from the group consisting of amino functional silane coupling agent, an epoxy functional silane coupling agent, a vinyl functional silane coupling agent. The organosilane coupling agent may be selected from the group consisting of N-β(aminoethyl)-γ-aminopropylmethyldimethoxysilane, N-β(aminoethyl)-γ-aminopropyltrimethoxysilane, γ-aminopropyltriethoxysilane, aminopropyltrimethoxysilane, aminopropylmethyldiethoxysilane, diethylmethyltriethoxysilane, bis(triethoxysilylpropyl)tetrasulfide, bis(triethoxycilylpropyl)disulphide, 3-glycidoxypropyltriethoxysilane, 3-glycidoxypropyltrimethoxysilane, 3-glycidoxypropylmethyldimethoxysilane, 2-(3,4-epoxycyclohexyl)-ethyltrimethoxysilane, vinyltrimethoxysilane, vinyltriethoxysilane, ethenyltriethoxysilane, vinyl(2-methoxyethoxy)silane, N-propyltrimethoxysilane, γ-methacryloxy-propyl trimethoxysilane, γ-mercaptopropyl trimethoxy silane, mercaptopropyltriethoxysilane, triethoxysilylpropylmercaptan, mercaptopropylmethyldimethoxysilane, 3-ureidopropyltrimethoxysilane, 3-ureidopropyltriethoxysilane, methyltrimethoxy silane, N-octyltriethoxy-silane and combinations thereof.

The coupling agent may chemically couple the modified clay to the plant protein polymeric matrix. The coupling agent may enhance the coupling strength and compatibility of the modified clay to the polymeric matrix. The coupling agent may aid to increase the dispersion and affinity of the modified clay to the polymeric matrix, even at high concentrations of the modified clay. In a preferred embodiment, the coupling agent is a silane coupling agent. The silane coupling agent may improve the clay dispersion and compatibility to polymers by chemical binding through epoxy reactive groups from the silane coupling agent, thereby forming a strong polymer composite.

The plant protein may be a prolamine protein, a derivative thereof or mixtures thereof. The prolamine protein may be selected from the group consisting of zein, gliadin, hordein, secalin, kafirin and avenin. The prolamine protein may have non-polar hydrophobic amino acid residues. Exemplary types of derivatives of the prolamine protein is provided in U.S. Pat. No. 2,518,666, the disclosure of which is incorporated by reference. The plant protein may form a film under suitable conditions such as the concentration of the plant protein, the pH and solvent used. The plant protein film may be able to act as a barrier layer to a gas such as oxygen or carbon dioxide.

In the polymer composite, the concentration of the modified clay in the polymer composite may be at least 50 wt %, or in the range of about 50 wt % to about 90 wt %, about 50 wt % to about 55 wt %, about 50 wt % to about 60 wt %, about 50 wt % to about 65 wt %, about 50 wt % to about 70 wt %, about 50 wt % to about 75 wt %, about 50 wt % to about 80 wt %, about 50 wt % to about 85 wt %, about 55 wt % to about 90 wt %, about 60 wt % to about 90 wt %, about 65 wt % to about 90 wt %, about 70 wt % to about 90 wt %, about 75 wt % to about 90 wt %, about 80 wt % to about 90 wt %, or about 85 wt % to about 90 wt %, based on the weight of said plant protein polymeric matrix.

Due to the presence of the silane coupling agent on the modified clay that couples the modified clay to the plant protein polymeric matrix, the resultant polymer composite may be compact with good miscibility. It is envisaged that in the polymer composite, the modified clay (having a sheet structure) has a hierarchical structure in which the plant protein polymeric matrix and antimicrobial agent (where present) create a longer tortuous path for diffusion of the gaseous molecules, thus reducing the permeation rate of the gas molecules through the polymer composite. Hence, the polymer composite may serve as a barrier to a gas (such as oxygen or carbon dioxide) in which the transmission or permeation of the gas across the interior of the polymer composite may be reduced by at least about 70%, at least about 75%, at least about 80%, at least about 85%, at least about 90%, at least about 95%, at least about 96%, at least about 97%, at least about 98%, or at least about 99%.

The polymer composite may also have an antimicrobial property such as antibacterial, antifungal or antiviral property. In order to exhibit the antimicrobial property, the polymer composite may be applied in the form of solution or gel to kill and inhibit the microbial growth on coated substrates. The polymer composite may be used to kill or inhibit Escherichia Coli, Staphylococcus aureus, Proteus, Pseudomonas and fungus. The antimicrobial agent such as chitosan, which is positively charged, may interact with negatively charged microbial cell membranes, leading to the leakage and destruction of microbial cell walls.

In addition, the polymer composite may be flexible and able to contour easily to adapt to a variety or surfaces or substrates where the polymer composite is to be coated or applied onto. The polymer composite may enhance the mechanical strength of the surface or substrate where the polymer composite is coated thereon. The improvement in the mechanical strength may be at least about 20%, at least about 30%, at least about 40%, at least about 50%, or at least about 60%. The polymer composite may be biodegradable.

When dried, the concentration of the plant protein polymeric matrix and the antimicrobial agent in the dried polymer composite may be at least 60 wt %, or in the range of about 60 wt % to about 99.9 wt %, about 65 wt % to about 99.9 wt %, about 70 wt % to about 99.9 wt %, about 75 wt % to about 99.9 wt %, about 80 wt % to about 99.9 wt %, or about 85 wt % to about 99.9 wt %, about 90 wt % to about 99.9 wt %, about 95 wt % to about 99.9 wt %, about 60 wt % to about 65 wt %, about 60 wt % to about 70 wt %, about 60 wt % to about 75 wt %, about 60 wt % to about 80 wt %, about 60 wt % to about 85 wt %, about 60 wt % to about 90 wt %, or about 60 wt % to about 95 wt %, based on the weight of the dried polymer composite.

Exemplary, non-limiting embodiments of a method of forming a polymer composite coating on a substrate will now be disclosed. The method comprises the step of applying a polymer composite composition on the substrate under conditions to form the coating thereon. The applying step may comprise coating the polymer coating composition on the substrate to form the coating thereon. The coating may include blade coating using a film applicator. The applying step may comprise immersing the substrate in the polymer composite composition or spraying the polymer composite composition onto the substrate.

The substrate may be polyethylene terephthalate, polypropylene, polyethylene or a food product. The food product may be an egg or a fruit. The thickness of the coating on the substrate may be in the range of about 0.05 to about 5 microns, about 0.05 to about 0.1 microns, about 0.05 to about 0.2 microns, about 0.05 to about 0.3 microns, about 0.05 to about 0.4 microns, about 0.05 to about 0.5 microns, about 0.05 to about 0.6 microns, about 0.05 to about 0.7 microns, about 0.05 to about 0.8 microns, about 0.05 to about 0.9 microns, about 0.05 to about 1 microns, about 0.05 to about 2 microns, about 0.05 to about 3 microns, about 0.05 to about 4 microns, about 0.1 to about 5 microns, about 0.15 to about 5 microns, about 0.2 to about 5 microns, about 0.3 to about 5 microns, about 0.4 to about 5 microns, about 0.5 to about 5 microns, about 0.6 to about 5 microns, about 0.7 to about 5 microns, about 0.8 to about 5 microns, about 0.9 to about 5 microns, about 1 to about 5 microns, about 2 to about 5 microns, about 3 to about 5 microns, about 4 to about 5 microns, or about 0.1 to about 0.2 microns.

The method may further comprise the step of, before the applying step, providing the polymer composite composition, wherein the polymer composite composition comprises a clay modified with a coupling agent and a plant protein.

The method may further comprise the step of heating the coated substrate. The heating step may be undertaken at a suitable temperature, such as in the range of about 100° C. to about 150° C., about 100° C. to about 110° C., about 100° C. to about 120° C., about 100° C. to about 130° C., about 100° C. to about 140° C., about 110° C. to about 150° C., about 120° C. to about 150° C., about 130° C. to about 150° C., or about 140° C. to about 150° C., depending on the type of substrate used. If the substrate used is biaxially oriented polypropylene or polyethylene substrate, the heating temperature may be about 105° C. while that for polyethylene may be about 130° C. The heating step may comprise a laminating step, optionally under pressure.

The method may further comprise the step of drying the coated substrate. The drying step may be vacuum drying or air flash drying. The drying step may be undertaken at room temperature or at an elevated temperature and for a period of time until the coated substrate is dried.

Exemplary, non-limiting embodiments of a multi-layered structure will now be disclosed. The multi-layered structure may comprise a polymer composite layer; and a polymer substrate layer, wherein the polymer composite layer is a layer comprised of a clay modified with a coupling agent; and a plant protein polymeric matrix.

The multi-layered structure may further comprise an adhesive layer to bind the polymer composite layer to the polymer substrate layer.

The thickness of the polymer composite layer may be in the range of about 0.1 to about 5 microns, about 0.1 to about 1 microns, about 0.1 to about 2 microns, about 0.1 to about 3 microns, about 0.1 to about 4 microns, about 1 to about 5 microns, about 2 to about 5 microns, about 3 to about 5 microns, or about 4 to about 5 microns.

The polymer substrate may be selected from the group consisting of polyethylene terephthalate, polypropylene and polyethylene. The polymer substrate may be also selected from the group consisting of polyethylene terephthalate, polypropylene, polyethylene, polycarbonate and nylon.

The multi-layered structure may further comprise another polymer substrate layer on the polymer composite layer to form a tri-layered structure.

Exemplary, non-limiting embodiments of a polymer composite composition will now be disclosed. The polymer composite composition comprises a liquid medium of a clay modified with a coupling agent; and a plant protein. The polymer composite composition may further comprise an antimicrobial agent.

The liquid medium may be made up of an aqueous solution, an organic solution or a mixture thereof. The organic solution may be miscible with water and may be an acetone or an alcohol. In some embodiments, the organic solvent may be a mixed solvent of acetone or alcohol with other polar solvents such as tetrahydrofuran, dimethylformamide and dimethyl sulfoxide. Depending on the type of solvent used to form the liquid medium, the modified clay and/or the plant protein may be dispersed in the polymer composite composition or form as a suspension in the polymer composite composition. The modified clay may act as a solid surfactant for dispersion of the plant protein in the aqueous solution.

The concentration of the modified clay in the polymer composite composition may be in the range of about 0.1 wt % to about 5 wt %, about 0.1 wt % to about 1 wt %, about 0.1 wt % to about 2 wt %, about 0.1 wt % to about 3 wt %, about 0.1 wt % to about 4 wt %, about 1 wt % to about 5 wt %, about 2 wt % to about 5 wt %, about 3 wt % to about 5 wt %, or about 4 wt % to about 5 wt %, based on the weight of modified clay in the polymer composites suspension.

The concentration of the plant protein in the polymer composite composition may be in the range of about 0.1 wt % to about 2 wt %, about 0.1 wt % to about 0.5 wt %, about 0.1 wt % to about 1 wt %, about 0.1 wt % to about 2 wt %, about 0.5 wt % to about 2 wt %, about 1 wt % to about 2 wt %, or about 1.5 wt % to about 2 wt %, based on the weight of plant protein in the polymer composite suspension.

The concentration of the antimicrobial agent in the polymer composite composition may be in the range of about 0.01 wt % to about 5 wt %, about 0.01 wt % to about 0.1 wt %, about 0.01 wt % to about 0.5 wt %, about 0.01 wt % to about 1 wt %, about 0.01 wt % to about 2 wt %, about 0.01 wt % to about 3 wt %, about 0.01 wt % to about 4 wt %, about 0.1 wt % to about 5 wt %, about 0.5 wt % to about 5 wt %, about 1 wt % to about 5 wt %, about 2 wt % to about 5 wt %, about 3 wt % to about 5 wt %, or about 4 wt % to about 5 wt %, based on the weight of antibacterial agent in the polymer composite suspension. Where the antimicrobial agent is chitosan, the concentration of the chitosan in the polymer composite composition may be in the range of about 0.1 to about 5 wt %. Where the antimicrobial agent is silver (such as silver nitrate or silver nanoparticles), the concentration of the silver nitrate or silver nanoparticles in the polymer composite composition may be in the range of about 0.01 to about 1 wt %.

Hence, the final concentration of the composite coating suspension may be in the range of about 0.5 to about 10 wt %, about 0.5 to about 1 wt %, about 0.5 to about 2 wt %, about 0.5 to about 3 wt %, about 0.5 to about 4 wt %, about 0.5 to about 5 wt %, about 0.5 to about 6 wt %, about 0.5 to about 7 wt %, about 0.5 to about 8 wt %, about 0.5 to about 9 wt %, about 1 to about 10 wt %, about 2 to about 10 wt %, about 3 to about 10 wt %, about 4 to about 10 wt %, about 5 to about 10 wt %, about 6 to about 10 wt %, about 7 to about 10 wt %, about 8 to about 10 wt %, about 9 to about 10 wt %, about 1 to about 5 wt % or about 2 to about 3 wt %, based on the weight of solid content in the polymer composite suspension.

The rest of the polymer composite composition is thus the liquid medium which is made up of about 90 to about 99 wt % of deionised water or a solvent mixture of a 75 vol % acetone or alcohol aqueous solution.

The polymer composite composition may further comprise additional additives in the composition. Where the liquid medium is made up of an aqueous solution, the aqueous solution can provide a platform for addition of various types of water-based polymer materials and/or antimicrobial agents in the polymer composite composition. In addition, even if the plant protein is insoluble in water, it may be advantageous to prepare the plant protein in the aqueous solution as the resultant polymer composite from the aqueous solution that is coated on a substrate may have a smoother and better compatibility with the substrate as compared to a coating derived from an organic based solvent. Further, the polymer composite composition may be applied onto a substrate surface without presenting any toxicity to the substrate that may be associated with the use of organic solvent(s), hence, the polymer composite composition may be applied directly onto food surfaces if the liquid medium used in the composition is an aqueous medium.

### BRIEF DESCRIPTION OF DRAWINGS

The accompanying drawings illustrate a disclosed embodiment and serves to explain the principles of the disclosed embodiment. It is to be understood, however, that the drawings are designed for purposes of illustration only, and not as a definition of the limits of the invention.

FIG. 1 is a number of Field Emission Scanning Electron Microscopy (FESEM) images at ×3,000 magnification showing the surface morphologies of PET films that have been coated with solvent (acetone/water at a ratio of 75:25) based polymer composites of (a) 5 wt % of zein; (b) Zein:MMT_30:70 and (c) Zein:GMMT_30:70, according to Example 1. The magnification of these images is ×3,000.

FIG. 2 is a number of FESEM images at ×3,000 magnification showing the surface morphologies of PET films that have been coated with polymer composites of (a) 3 wt % Zein:GMMT_20:80_solvent based; (b) 3 wt % Zein:GMMT_20:80_water based and (c) 2.5 wt % Zein:GMMT:Chitosan_12:48:40_water based, according to Example 1.

FIG. 3 is a bar graph depicting the oxygen bather property of water based 1 wt % Chitosan, Zein:GMMT_20:80 and Zein:GMMT:Chitosan_12:48:40 composites coated PET films.

FIG. 4 is a number of photographic images of agar plates demonstrating the evaluation of antimicrobial property of (a) I water; II Zein:GMMT:Chitosan suspension; (b) I Zein:GMMT:Chitosan coated PET films; II Zein:GMMT:Chitosan:AgNO₃ coated PET films and (c) Zein:GMMT:Chitosan:Ag coated PET film.

FIG. 5 is a number of FESEM images at ×3,000 magnification showing the surface morphologies of chicken egg shells coated with (a) water; (b) Zein:GMMT:Chitosan and cross section view of (c) water; (d) Zein:GMMT:Chitosan.

FIG. 6 is a number of photographic images showing chicken eggs coated with (a) water; (b) Zein:GMMT_20:80 and (c) Zein:GMMT:Chitosan_12:48:40.

FIG. 7 is a bar graph depicting the puncture strength of chicken eggs coated with water and composites.

### EXAMPLES

Non-limiting examples of the invention will be further described in greater detail by reference to specific Examples, which should not be construed as in any way limiting the scope of the invention.

### Example 1—Preparation of Zein:Clay Composites Coated PET Film

### Preparation of GPTMS Modified Clay Suspension (GMMT)

20 g of pristine clay (montmorillonite) obtained from Nanocor Inc. of Arlington Heights of Illinois of the United States of America was mixed with 800 ml deionised water and stirred for 6 hours, followed by ultrasonication in a water-bath for 30 minutes. Then, 1.2 ml of acetic acid was added to the solution and stirred for another 12 hours at room temperature. To exchange water with acetone, acetone was added to the suspension. The clay suspension was homogenized with acetone using IKA T18 Basic Ultra Turrax homogenizer at 15,000 rpm for 5 minutes. Thereafter, the slurry precipitate was filtered with a Buchner funnel and washed with acetone. The collected slurry precipitate was re-suspended into acetone and homogenized for 5 minutes at 15,000 rpm, followed by filtration and washing. Sufficient amount of acetone to water of about 3:1 vol % was used for a fast and efficient washing process. After a second cycle, the collected precipitate was transferred to a round bottom flask, and then topped up with known amount of acetone. 1.0 g of (3-glycidoxypropyl)trimethoxysilane (≥98%, Aldrich) was added to the solution. After stiffing for 8 hours at room temperature, the mixture was ultrasonicated for 30 minutes and stirred at 50° C. for 8 hours. GMMT stock solution is now ready for use. Excess amount of acetone can be removed by rotary evaporation at 60° C. before use.

### Preparation of Zein Solution

10 g of zein (grade Z3625 from maize) obtained from Sigma Aldrich Singapore was dissolved in 75 vol % acetone aqueous solution with stirring, followed by ultrasonication in a water-bath for 5 minutes. The solution was then heated at 70° C. with stiffing for 1 hour to fully dissolve the zein. After cooling to room temperature, an acidified zein solution was prepared by adjusting the pH of the final solution to about 4 using acetic acid.

### Preparation of Zein:Clay Composites Suspension (Zein:GMMT)

Zein:GMMT composites suspension was prepared by mixing GMMT suspension and zein solution at a specific range of wt % ratio (Zein:GMMT=50-10:50-90) under high speed of stiffing. All suspension concentration is controlled at 3 wt %. To prepare a solvent-based composite suspension, the GMMT suspension as prepared above was first dispersed in 75 vol % acetone aqueous solution. Then, zein solution as prepared above (75 vol % acetone aqueous solution) was added dropwise to the GMMT suspension under stiffing. After mixing for 1 hour, the composites solution was sonicated for 5 minutes, and then heated at 70° C. for 3 hours under stiffing. After cooling to ambient temperature, the mixture was continuously stirred for another 8 hours to obtain a homogenous suspension. As for water-based composites suspension, all acetone was slowly evaporated using a rotary evaporator at 60° C., and replaced by the same volume of deionised water. The mixture was continuously stirred for another 8 hours. Optionally, the mixture can be homogenized at 15,000 rpm for 10 minutes using an IKA T18 Basic Ultra Turrax to obtain a homogenous suspension.

The polymer composites coating suspensions were blade coated onto a polyethylene terephthalate (PET) film by using a film applicator with an applicator bar coating gap controlled at 50 μm. The applied polymer composites layer was then dried by air flash at room temperature for 24 hours, followed by drying in a vacuum oven at 60° C. for 24 hours. The oxygen transmission rates (OTR) and water vapour transmission rates (WVTR) are shown in Table 1.

TABLE 1
Oxygen and Water Vapor Transmission Rates of Films

| | | OTR (cc/ | WVTR (gm/ |
|---|---|---|---|
| Type of Film* | Medium | [m² · day]) | [m² · day]) |
| PET | — | 130.44 | 46.49 |
| Zein:GMMT_50:50 @PET | (CH₃)₂CO:H₂O | 11.12 | 42.37 |
| Zein:GMMT_40:60 @PET | (CH₃)₂CO:H₂O | 11.01 | 40.80 |
| Zein:GMMT_30:70 @PET | (CH₃)₂CO:H₂O | 8.97 | 38.30 |
| Zein:GMMT_20:80 @PET | (CH₃)₂CO:H₂O | 8.26 | 40.37 |
| Zein:GMMT_10:90 @PET | (CH₃)₂CO:H₂O | 1.15 | 38.93 |
| Zein:GMMT_50:50 @PET | H₂O | 11.86 | 40.96 |
| Zein:GMMT_40:60 @PET | H₂O | 2.68 | 40.99 |
| Zein:GMMT_30:70 @PET | H₂O | 2.69 | 38.41 |
| Zein:GMMT_20:80 @PET | H₂O | 0.50 | 38.73 |
| Zein:GMMT_10:90 @PET | H₂O | 2.05 | 39.49 |

*Thickness of the composite layer was controlled at about 1-2 μm. The composite layer was coated with 3 wt % of Zein/GMMT suspension.

As demonstrated in Table 1, all polymer composites coated PET films either from solvent-based or water-based coating solution showed good oxygen bather property. While the thickness of PET film is about 12 μm, the thickness of the coated composites layer is about 1-2 μm.

The OTR were measured by using a Mocon oxygen permeability OX-TRAN Model 2/21 according to ASTM D3985. Each film was placed on a stainless steel mask with an open testing area of 5 cm². Oxygen permeability measurements were conducted at 23° C. (1 atm) and 0% relative humidity by placing coated surface of films to the oxygen rich side. In addition, the water vapor permeability of the samples was measured by using a Mocon water vapor permeability PERMATRAN-W Model 3/33 according to ASTM F1249. Each film was placed on a stainless steel mask with an open testing area of 5 cm². Water vapor permeability measurements were conducted at 37.8° C. (1 atm) and 90% relative humidity by placing coated surface of films to the water vapor rich side.

As can be seen in Table 1, all of the composites layer coated PET films showed significant improvement of oxygen bather in comparison to that of pure PET film (>90-99% reduction). Moreover, it is believed that due to the high concentration of clay, a water-based medium is preferred for a better dispersion and miscibility in the composites. The lowest OTR of the composites/PET film was measured as 0.50 cc/(m²·day). Meanwhile, there is a slight reduction in the water vapour transmission rate in the range of 8 to 17% reduction, which is due to the nature of the composites in which the composites are sensitive to moisture at high temperature and high relative humidity.

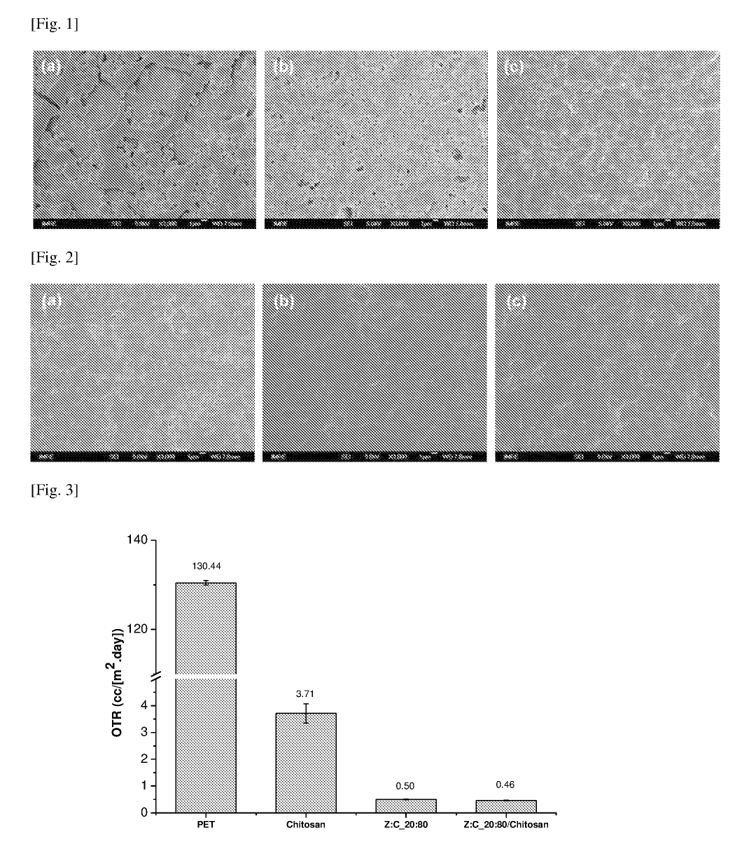

FIG. 1 and FIG. 2 show FESEM images of the surface morphologies of a number of samples. The FESEM images were obtained by using a high-resolution scanning electron microscope (FE-SEM, JEOL JSM-6700F). The coated samples were placed firmly on the stab using carbon adhesive tabs and gold coated before imaging.

As observed in FIG. 1(a), part of the zein molecules were aggregated into spherical particles on the coated surfaces even at relatively high concentration (5 wt % of zein). Meanwhile, as observed in FIG. 1(b) and FIG. 1(c), no spherical particle was observed for zein:clay composites, even at 0.9 wt % of zein. It is postulated that the strong interaction and intercalation of zein molecules between the silane treated clay silicate sheets has prevented the aforementioned aggregation. However, in FIG. 1(b), which is based on pristine (or unmodified) clay with zein composites, many gaps or holes could be seen in the composite, leading to the composite having poor bather property. As such, the inventors have found that in order to prevent the formation of such gaps or holes so as to maintain the barrier property of the composite, the concentration of the pristine clay need to be decreased to less than 10 wt %. In contrast, as seen in FIG. 1(c), where modified clay (based on silane as a coupling agent) is used for the fabrication of zein:clay composites, even at high concentration of the modified clay (which is 70 wt % in FIG. 1(c)), the gaps or holes that were present in FIG. 1(b) are noticeably absent in FIG. 1(c). Hence, the use of silane modified clay can be used to increase the concentration of modified clay used, leading to an enhanced barrier layer.

FIG. 2(a) shows the surface morphology of a PET film coated with 3 wt % of solvent based Zein:GMMT (at a ratio of 20:80). As compared to FIG. 2(b), which is the same polymer composite but made from a water based solution, it can be seen that the water-based zein:clay composites coated film (FIG. 2(b)) showed a smoother and better compatibility layer as compared to the solvent-based coated layer (FIG. 2(a)). Hence, in addition to the above advantage, water-based zein:clay composites can also be used to provide a good platform for addition of various types of water-based polymeric materials and antimicrobial agents into the coating solution.

Furthermore, as observed in FIG. 2(b), the surface morphology of water-based polymer composites coated films have further reduced the oxygen permeation rates, and is particularly significant for zein:clay composites at 20:80 wt % ratio. This may be due to the strong bonding of zein to silane treated clay to form a more compact network film.

### Example 2—Preparation of Zein:Clay:Chitosan Composites Coated Film

In order to form the zein:clay:chitosan composite coated film, the zein:clay:chitosan composite suspensions for coating onto a film were formed as shown below.

### Preparation of Chitosan Solution

2 wt % chitosan solution was prepared by dissolving 1.0 g of chitosan (low molecular weight, Aldrich) in 2 wt % of acetic acid aqueous solution (50 ml deionised water) under stirring. The solution was then heated at 60° C. for 3 hours with stirring until total homogenization of the solution. After cooling, the pH of final solution was adjusted to about 4 using acetic acid.

### Preparation of Zein:Clay:Chitosan Composites Suspension (Zein:GMMT:Chitosan)

Chitosan solution obtained from above was added into appropriate amounts of water based Zein:GMMT_20:80 composites solution obtained above under high speed homogenization process at 15,000 rpm for 10 minutes using an IKA T18 Basic Ultra Turrax. The final concentration of composites was 2.5 wt % with 10 mg/ml of chitosan in the composites or Zein: GMMT:Chitosan_12:48:40.

### Preparation of Zein:Clay:Chitosan:Ag Composites Suspension (Zein:GMMT:Chitosan:Ag)

Silver nitrate (ACS reagent, ≥99.0%, Sigma-Aldrich of St. Louis of Missouri of the United States of America) was dissolved in deionised water. Zein:Clay:Chitosan composites containing Ag ions can be prepared simply by mixing AgNO3 aqueous solution into Zein:Clay:Chitosan composites suspension. A small amount of trisodium citrate dihydrate (Sigma-Aldrich) was added into the solution to completely reduce the AgNO3 to Ag nanoparticles. Alternatively, prior clay modification with silane, AgNO3 was dissolved into pristine MMT suspension, followed by chemical reduction using trisodium citrate dihydrate to obtain Ag nanoparticles immobilized onto MMT clay sheets for further use.

The polymer composites coating suspensions (including the chitosan therein) were blade coated onto a polyethylene terephthalate (PET) film by using a film applicator with an applicator bar coating gap controlled at 50 μm. The applied polymer composites layer was then dried by air flash at room temperature for 24 hours, followed by drying in a vacuum oven at 60° C. for 24 hours.

FIG. 2(c) shows the PET film coated with the zein:clay:chitosan composite. As can be seen from FIG. 2(c), the surface morphology of the coated layer is smooth without any cracks or holes. This may be due to the interaction between the silane coupling agent of the modified clay that is able to react with the chitosan to immobilize it in place.

The PET film coated with the zein:clay:chitosan composite was then tested for its oxygen barrier property based on the same test measurement mentioned above. FIG. 3 thus shows the results between PET films used as is, coated with water based 1 wt % chitosan, coated with zein:GMMT (20:80 ratio) and coated with zein:GMMT:chitosan (12:48:40 ratio). FIG. 3 showed that for 1 wt % of chitosan film, relatively good oxygen transmission rate can be achieved at 3.71 cc/(m²·day). Addition of similar amount of chitosan to the zein:clay composites at 20:80 wt % ratio has further improved the oxygen bather to as low as 0.46 cc/(m²·day). It is believed that the zein:clay composites plays a dominant role in reducing the oxygen transmission rate. Reduction of ˜3 cc/(m²·day) is very important to protect a wider range of food products from oxidation in packaging applications, especially for oxygen sensitive food and beverages. In addition, the presence of chitosan in the polymer composites acts as an effective antimicrobial agent.

The zein:clay:chitosan composite is then used for antimicrobial testing. The zein:clay:chitosan composites were tested in 1) solution, 2) coated onto a PET film, and 3) made into a film and dried.

The antimicrobial activity of the various samples was tested via spread plate technique. Plate Count Agar (PCA) plates were first prepared. Microorganisms (believed to include Escherichia Coli, Staphylococcus aureus, Proteus, Pseudomonas, fungal, etc) from egg shell surfaces were collected into peptone water (0.1% w/v peptone) diluent via rubbing in a sterile plastic bag. Dilutions were performed to determine the concentration of colonies per plate (1.2-1.5×10⁴ CFU/ml). From dilution, 100 μL of aliquots were withdrawn and surface-plated using spreader onto PCA plates. Then, 25 μL of water (as control) or polymer composites solution were dropped onto the PCA plates. As for the PET film and polymer composites coated dried film, the films were cut into 10 mm in diameter using Acu-Punch. The coated sides were then placed onto the PCA plates. All the plates were examined for possible inhibition zone after incubation at 37° C. for 48 hours. The presence of clear zone that formed on the surface of PCA plate indicates inhibition against the microorganisms.

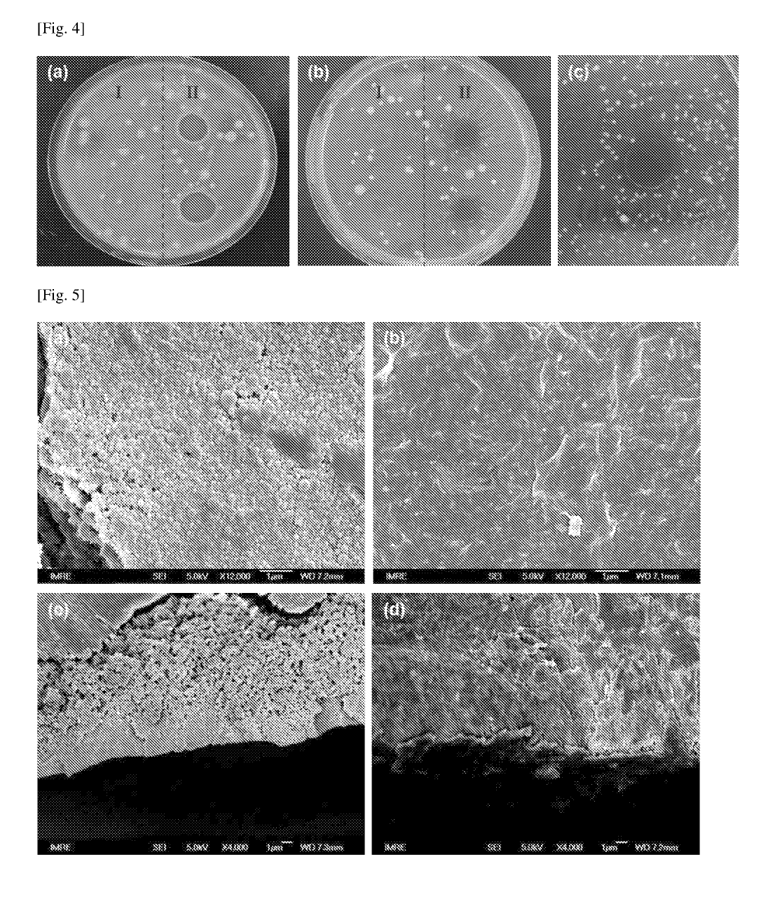

As observed in FIG. 4(a), there was no inhibition zone on PCA medium when 25 μL of water was used as control (see side I of FIG. 4(a)). Meanwhile, zein:clay:chitosan composites suspension exhibited a very strong antimicrobial activity. A clear zone of inhibition can be observed on the whole PCA surface, where 25 μL of zein:clay:chitosan suspension was loaded (see side II of FIG. 4(a)). The antimicrobial action is believed to occur when positively charged chitosan molecules interact with negatively charged microbial cell membranes, leading to the leakage and destruction of microbial cell walls. In contrast to the strong antimicrobial activity of zein:clay:chitosan suspension, a dried film that was prepared from the same solution showed no significant microbial inhibition (see side I of FIG. 4(b)). This could be explained by the limitation of chitosan diffusion in agar medium when dried. In order to achieve the antimicrobial effect, the zein:clay:chitos an composites can be applied in the form of solution or gel to kill and inhibit the microbial growth on the coated substrates. Hence, the zein:clay:chitosan composite can also be suitable for use in wet food packaging or coating on films with high water vapour permeability.

If dried food is to be packaged, an antimicrobial agent such as silver based compounds can be used. Hence, low concentration of silver nitrate or silver nanoparticles can be incorporated into the polymer composites. It is evident that the PET film as control does not possess antimicrobial activity, exhibiting the absence of an inhibition zone and heavy microbial growth on the medium under the films. By comparison, zein:clay:chitosan:Ag (1 wt % of AgNO₃) coated PET film (as seen in side II of FIG. 4(b)) exhibited a clear inhibition zone against microbial, and there is no growth of microbial on this film, illustrating that this composite possessed excellent antimicrobial activity. The antimicrobial effect is directly related to the presence of Ag ions or Ag nanoparticles and the suppressing effect is more pronounced for composites with AgNO₃ sample as shown in side II of FIG. 4(b). The inhibition zone can have a diameter of about 2 to 3 mm for Ag nanoparticles (see FIG. 4(c)) and about 4 to 5 mm for AgNO₃ (see side II of FIG. 4(b)). This may be due to the slow release of Ag ions from the silver nanoparticles that can diffuse into the medium surrounding the film to suppress the growth of microbial, which is demonstrated by the inhibition zone around the films. In order to obtain the Ag ions, the Ag ions can be reduced to Ag nanoparticles in alkaline condition. The colour of clay suspension was changed to light brown when AgNO₃ solution was gradually added into clay suspension (pH˜9).

### Example 3—Preparation of a Barrier Coating Layer on Egg Shells Using the Polymer Composite Solution

Here, fresh chicken eggs were used as a representation of real food product. The polymer composites tested in this example are Zein:GMMT (at a ratio of 20:80) and Zein:GMMT:Chitosan (at a ratio of 12:48:40). The polymer composite was uniformly coated on the shell surfaces of 30 eggs to form a barrier layer similar to that of zein:clay:chitosan suspension coated PET film in FIG. 2 (c). The thickness of the barrier layer formed on the egg was 150 nm. Prior to coating, eggs were washed and rinsed using deionised water at 43.3° C., followed by air flash drying at room temperature. After washing, the dried eggs were immersed in polymer composites coating solution for about 1 minute and dried at ambient temperature for 24 hours. The immersion was repeated to obtain two layers of coating.

The surface morphologies of the egg shells coated with water are shown in FIG. 5 (a) and FIG. 5(c) (with FIG. 5(c) showing the cross section view of the egg shell). As can be seen, the egg shell is riddled with pores. Moisture and carbon dioxide can be lost easily from these shell pores. After coating with the Zein:GMMT:Chitosan composites, the pores were hidden (as can be seen in FIG. 5(b) and FIG. 5(d), with FIG. 5(d) showing the cross section view of the coated egg shell).

Hence, due to the coating on the shell, the pores on the egg shell can be substantially covered by the coating layer acting as a barrier layer. This barrier layer may prevent loss of moisture and carbon dioxide from the albumen through the shell pores, thereby maintaining the albumen pH and prolonging the shelf life of the egg. The barrier layer can also retard the transfer rate of oxygen and prevent contaminants from contacting with the food product. In addition, the barrier layer formed from the polymer composite can provide a good line of defence against invading microbial. Consequently, this may slow down the metabolism process and reduce undesirable change of appearance.

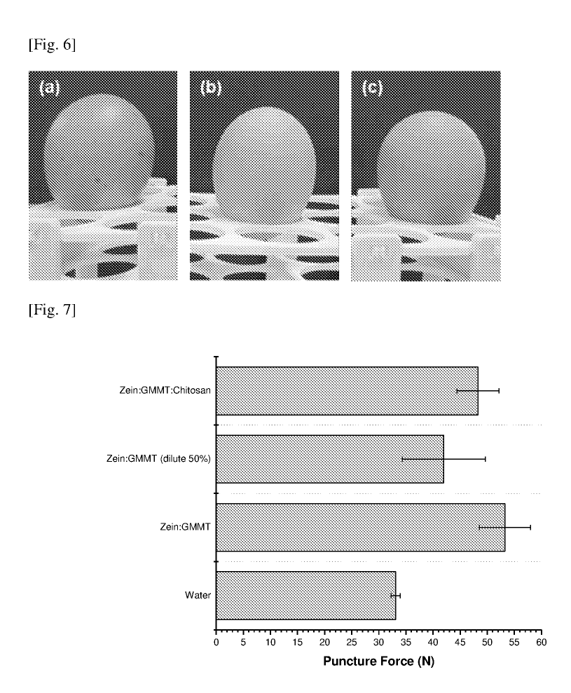

As illustrated in FIG. 6, there is no significant difference in appearance for polymer composites coated eggs as compared to control egg. It is to be appreciated that the polymer composites coated eggs are easy to handle. In addition, the drying process after coating is very fast (within 1 to 2 hours) at ambient temperature. Furthermore, due to the presence of clay silicate sheets in the polymer composites, the clay sheets aid in increasing the mechanical strength of the egg shells. A good mechanical strength of egg shell is important to protect the egg from cracked or broken on the processing line and during transportation. The puncture strength of eggs with or without coating was then performed using a Texture Analyser (TA.XT2i). The egg was mounted on a stable platform and the top side of the egg shell was punctured using a 6 mm diameter cylinder probe at 5 mm/s constant speed in a compression mode. The force required to puncture the egg shell (N) to a penetration distance of 6 mm was recorded. Puncture force (N) as shown in FIG. 7 is an indication of the maximum stress at break. As compared to the non-coated egg using water as control, Zein:GMMT coating has significantly increased the mechanical strength of coated egg shells by 60%. Dilution of coating solution up to 50% still showed greater puncture strength than non-coated eggs to about 27%. Addition of chitosan to the Zein:GMMT composites also revealed very good mechanical strength of shells by 49%. This indicates the important role of silane treated clay silicates in the composites for enhancing the mechanical strength of coating.

### INDUSTRIAL APPLICABILITY

The polymer composite may be used in food and beverage packaging, as a coating for food, as an antimicrobial coating for foods and pharmaceutical products, in the plastic and converted industry and in the paper industry (where the polymer composite can be used as a antimicrobial and barrier layer).

The polymer composite may be used to protect the contents of a package from oxidation or deterioration. In addition, the incorporation of an antimicrobial agent such as chitosan, silver nitrate or silver nanoparticles may prolong the shelf life of the packaged food. The polymer composite may be suitable for use in wet food packaging or coating on films with high water vapour permeability. The polymer composite may be used as a coating on food products such as eggs or fruits to extend the shelf lives of the food product. Where the food product is an egg, the polymer composite may result in preserving the interior quality of the egg due to the retardation of oxygen across the egg shell and may prevent contaminants from contacting with the egg interior.

It will be apparent that various other modifications and adaptations of the invention will be apparent to the person skilled in the art after reading the foregoing disclosure without departing from the spirit and scope of the invention and it is intended that all such modifications and adaptations come within the scope of the appended claims.

1. A polymer composite comprising:
a. a clay modified with a coupling agent; and
b. a plant protein polymeric matrix,
wherein said coupling agent couples said modified clay to said plant protein polymeric matrix.

2. The polymer composite according to claim 1, further comprising an antimicrobial agent coupled to said coupling agent.

3. The polymer composite according to claim 1, wherein said coupling agent is a silane coupling agent.

4. The polymer composite according to claim 3, wherein said silane coupling agent is an organosilane coupling agent, selected from the group consisting of amino functional silane coupling agent, an epoxy functional silane coupling agent, a vinyl functional silane coupling agent.

5. (canceled)

6. The polymer composite according to claim 5, wherein said organosilane coupling agent is selected from the group consisting of N-β(aminoethyl)-γ-aminopropylmethyldimethoxysilane, N-β(aminoethyl)-γ-aminopropyltrimethoxysilane, γ-aminopropyltriethoxysilane, aminopropyltrimethoxysilane, aminopropylmethyldiethoxysilane, diethylmethyltriethoxysilane, bis(triethoxysilylpropyl)tetrasulfide, bis(triethoxycilylpropyl)disulphide, 3-glycidoxypropyltriethoxysilane, 3-glycidoxypropyltrimethoxysilane, 3-glycidoxypropylmethyldimethoxysilane, 2-(3,4-epoxycyclohexyl)-ethyltrimethoxysilane, vinyltrimethoxysilane, vinyltriethoxysilane, ethenyltriethoxysilane, vinyl(2-methoxyethoxy)silane, N-propyltrimethoxysilane, γ-methacryloxy-propyl trimethoxysilane, γ-mercaptopropyl trimethoxy silane, mercaptopropyltriethoxysilane, triethoxysilylpropylmercaptan, mercaptopropylmethyldimethoxysilane, 3-ureidopropyltrimethoxysilane, 3-ureidopropyltriethoxysilane, methyltrimethoxy silane, N-octyltriethoxy-silane and combinations thereof.

7. The polymer composite according to claim 1, wherein said plant protein is a prolamine protein, a derivative thereof or mixtures thereof, wherein said prolamine protein is selected from the group consisting of zein, gliadin, hordein, secalin, kafirin and avenin.

8. (canceled)

9. The polymer composite according to claim 2, wherein said antimicrobial agent is selected from the group consisting of chitosan, a chitosan derivative compound, a transition metal, an inorganic oxide and combinations thereof;
wherein said chitosan derivative compound is a chitosan-arginine compound, a chitosan-guanidine compound, a methyl-thiocarbamoyl chitosan derivative, a phenylthiocarbamoyl chitosan derivative and a chitosan-lysine compound;
wherein said transition metal is selected from the group containing of copper, cobalt, nickel, zinc, silver, ruthenium, platinum, rhodium, iridium, palladium, osmium, manganese and combinations thereof; and
wherein said inorganic oxide is selected from the group consisting of magnesium oxide, zinc oxide, silver oxide, titanium oxide, copper oxide and calcium oxide.

10. (canceled)

11. (canceled)

12. (canceled)

13. The polymer composite according to claim 1, wherein the concentration of said modified clay in the polymer composite is at least 50 wt %, based on the weight of said plant protein polymeric matrix.

14. A method of forming a polymer composite coating on a substrate comprising the step of applying a polymer composite composition on said substrate under conditions to form said coating thereon.

15. The method according to claim 14, further comprising the step of, before said applying step, providing said polymer composite composition, wherein said polymer composite composition comprises a clay modified with a coupling agent and a plant protein.

16. The method according to claim 14, further comprising the step of
heating said coated substrate or;
drying said coated substrate.

17. (canceled)

18. A multi-layered structure comprising:
a. a polymer composite layer; and
b. a polymer substrate layer,
wherein said polymer composite layer is a layer comprised of:
i. a clay modified with a coupling agent; and
ii. a plant protein polymeric matrix.

19. The multi-layered structure according to claim 18, further comprising an adhesive layer.

20. The multi-layered structure according to claim 18, wherein polymer substrate is selected from the group consisting of polyethylene terephthalate, polypropylene and polyethylene.

21. A polymer composite composition comprising a liquid medium of
a. clay modified with a coupling agent; and
b, a plant protein.

22. The polymer composite composition according to claim 21, further comprising an antimicrobial agent.

23. The polymer composite composition according to claim 21, wherein said solution is an aqueous solution or an organic solution;
wherein said organic solution comprises acetone.

24. (canceled)

25. The polymer composite composition according to claim 21, wherein the concentration of said modified clay is in the range of 0.1 wt % to 5 wt %, based on the weight of modified clay in the polymer composites suspension.

26. The polymer composite composition according to claim 21, wherein the concentration of said plant protein is in the range of 0.1 wt % to 2 wt %, based on the weight of plant protein in the polymer composite suspension.

27. The polymer composite composition according to claim 21, wherein the concentration of said antimicrobial agent is in the range of 0.01 wt % to 5 wt %, based on the weight of antibacterial agent in the polymer composite suspension.
